(19) United States
(12) Patent Application Publication
(10) Pub. No.: US 2011/0145656 A1
(43) Pub. Date: Jun. 16, 2011

(54) Analyzing A Distributed Computer System

(75) Inventors: Friedemann Baitinger, Jettingen (DE); Claudia Fischer, Stuttgart (DE); Walter Niklaus, Stuttgart (DE); Ralf Schaufler, Boeblingen (DE)

(73) Assignee: INTERNATIONAL BUSINESS MACHINES CORPORATION, Armonk, NY (US)

(21) Appl. No.: 12/916,507

(22) Filed: Oct. 30, 2010

(30) Foreign Application Priority Data
Dec. 15, 2009 (DE) 09179282.0

(51) Int. Cl. G06F 11/34

(52) U.S. Cl. 714/45; 714/E11.2

(57) ABSTRACT

Analyzing a distributed computer system, wherein said distributed computer system comprises at least one hardware unit to process data, an interconnection network and at least one processing unit to initialize said at least one hardware unit by using said interconnection network. According to the inventive method different trace files generated by components of said distributed computer system are post-analyzed and trace lines inside said different trace files belonging to the same action executed from at least one component inside said distributed computer system are identified by using unique key expressions, wherein an output file with context and/or time distribution information for different actions is generated by extracting trace lines representing cross process or cross controller calls and/or function calls for each related action based on an input file.

This application claims priority under 35 U.S.C. §119 to European Patent Application No. 09179282.0 filed Dec. 15, 2009, the entire text of which is specifically incorporated by reference herein.

### BACKGROUND OF THE INVENTION

1. Field of the Invention

The present invention relates in general to the field of analyzing the performance of a computer system, and in particular to methods, apparatus, and computer program products for analyzing operations of a distributed computer system.

2. Description of Related Art

A System z mainframe is initialized for example via an out of band service network consisting of a support element like a Thinkpad™ and multiple flexible support processors (FSP) with embedded controller comprising a processor. The support element is connected to multiple flexible support processors which in turn have access methods to the hardware units of the System z. During Initialization an enormous amount of actions have to be done. Such actions are initiated in parallel on the support element. Most of those actions are forwarded to one of the flexible support processors via a defined communication protocol. The flexible support processor interprets the action and translates it to one or more hardware access(es) to a hardware unit of the System z. The flexible support processor notifies the support element about successful completion of the action. So each action consists of parts which are executed on the support element, on a flexible support processor and on a hardware unit. The total initialization of a System z can take several minutes and is very performance critical because it has to be executed thousands of times during bring-up of the System z and therefore consumes a lot of expensive machine time. The initialization time also contributes to the customer downtime after an UIRA and is therefore critical.

Known solutions are for example profiling tools. However those can only be applied on one controller of a distributed system. Also no tool keeps track of how an action is distributed over several controllers of a system, which means, that the analysis does not take the context of an action into account. For example, it is not possible to measure the amount of hardware accesses needed for a specific hardware initialization step, if the support element is calling to functions on the flexible support processor, that contain multiple hardware accesses. In addition common profiling tools are executed during run time or need some special instrumentation of the source code, which requires a rebuild. Both methods are slightly changing the behavior of the analyzed program.

In the patent application publication US 2007/0220360 A1 “Automated display of trace historical data” by Weiners et al. a method for causing a computing system to automatically displaying historical data on a display in a manner is disclosed that the flow of processing activity may be observed across multiple processing entities. According to the disclosed method context among trace data for representing processing control transfer is determined. The intuitive display of trace historical data is done in a manner that processing control transfer between processing entities is represented in the context of trace data from multiple processing entities. For each processing entity, a set of one or more trace entries are identified for that processing entity and displayed in a manner that the trace entries for the processing entity are shown associated with the processing entity. The transfer of control between processing entities is also shown in a manner that illustrates a transfer of processing control. The trace entry also may include an activity identifier that identifies the activity that the trace entry belongs to. Here an “activity” is a sequence of trace entries that have resulted from processing performed by a processing entity. The trace entries may describe actions performed by a number of different processing entities. Accordingly, the trace entries may include trace entries from different activities. The activity identifier may be used to identify the trace sequence or “activity” that the trace comes from. The absence of an activity identifier may imply that the trace entry is part of a particular activity. Alternatively or in addition, extrinsic information may be used to identify the activity even if the trace entry itself contains no activity identifier per se. The trace entry also includes a time stamp that represents the rendering of time at the system that generated the trace entry at the approximately the time that the action recorded by the trace entry occurred. The trace entry may also have correlation data if the action represents the partial or full passage of processing control from one processing entity to another. The correlation data allows the actions on different processing entities to be correlated when those actions involved the transfer of processing control.

The described method requires that the traces contain an activity identifier, wherein cross process calls within the same processing entity for sub function calls within the same process are not displayed. Additionally, the described method is not configurable and acts always on all traces.

### SUMMARY OF THE INVENTION

The technical problem underlying the invention is to provide a method and apparatus for analyzing a distributed computer system, which are able to overcome the mentioned uncertainties of the prior art solutions and to improve the analyzing and understanding of the performance related behavior of the distributed computer system, and especially to analyze and improve the performance of the distributed computer system during the initialization time, and to provide a data processing program and a computer program product to perform the method for analyzing a distributed computer system.

In an embodiment of the present invention a method for analyzing a distributed computer system, wherein the distributed computer system comprises at least one hardware unit to process data, an interconnection network and at least one processing unit to initialize the at least one hardware unit by using said interconnection network, comprises that different trace files generated by components of the distributed computer system are post-analyzed and trace lines inside the different trace files belonging to the same action executed from at least one component inside the distributed computer system are identified by using unique key expressions, wherein an output file with context and/or time distribution information for different actions is generated by extracting trace lines representing cross process or cross controller calls and/or function calls for each related action based on an input file.

In further embodiments of the present invention, a list of full traces and a list of calls are created by parsing each trace file line by line, wherein each full trace and each call comprise trace lines belonging to the same action in consecutive order.

In further embodiments of the present invention, the list of full traces and the list of calls are used to create a list comprising trace lines representing cross process or cross controller calls and/or function calls for each related action based on the input file.

In further embodiments of the present invention, the input file describes format of the trace files and specifies function calls and formats of cross process or cross controller calls to be analyzed.

In further embodiments of the present invention, each of the trace files contains process identification information and timestamp information and unique key expressions.

In further embodiments of the present invention, the trace files and/or the input file are specified as XML files.

In further embodiments of the present invention, the different trace files are analyzed to reduce time duration of an initializing process of the distributed computer system.

In further embodiments of the present invention, the output file is transformed in a format to be used in an SQL (Structured Query Language) database or in a comma separated value list.

In another embodiment of the present invention, apparatus for analyzing a distributed computer system is provided, wherein the distributed computer system comprises at least one hardware unit to process data, an interconnection network and at least one processing unit to initialize the at least one hardware unit by using the interconnection network. According to the invention a controller unit is post-analyzing different trace files generated by components of the distributed computer system and identifying trace lines inside the different trace files belonging to the same action executed from at least one component inside the distributed computer system by using unique key expressions, wherein the controller unit generates an output file with context and/or time distribution information for related actions by extracting trace lines representing cross process or cross controller calls and/or function calls for each related action based on an input file.

In further embodiments of the present invention, the controller unit creates a list of full traces each comprising trace lines belonging to the same action executed from at least one component inside the distributed computer system by extracting cross process or cross controller calls and/or function calls based on an the input file describing formats of the trace files and specifying function calls and formats of cross process or cross controller calls to be analyzed.

In further embodiments of the present invention, the controller unit analyzes each full trace of the list of full traces to calculate duration of a function call specified by the input file if a trace line representing the function call and a trace line representing a related function end is found inside the full trace.

In further embodiments of the present invention, the at least one processing unit comprises at least one flexible support unit and at least one support element connected to the at least one flexible support unit.

In further embodiments of the present invention, the at least one flexible support unit comprises an embedded controller with a support processor executing different tasks, wherein the at least one support element comprises a Thinkpad™ with a processor executing different tasks.

In another embodiment of the present invention, a data processing program for execution in a data processing system comprises software code portions for performing a method for analyzing a distributed computer system when the program is run on the data processing system.

In yet another embodiment of the present invention, a computer program product stored on a computer-usable medium, comprises computer-readable program means for causing a computer to perform a method for analyzing a distributed computer system when the program is run on the computer.

The core idea of this invention is to use a trace file for determination of time distribution and context and/or relationship between sub tasks which are executed by controllers of the mainframe system during platform and/or controller change and cross function transactions for performance evaluation of transactions.

All in all, embodiments of the invention disclosed herein exploit traces, which are inherent in nearly every system to analyze the time distribution and context for multiple user specified transactions. The user defines which traces should be used to start or stop the measurement of a certain action. In addition the user can specify trace entries for inter process communication containing a sequence identification which is already used in the system and makes it possible to analyze the time distribution and context of a transaction also in a system with many controllers, without losing the context in case of a platform or process change.

The main advantage of the proposed solution is that the context of a function call can be taken into account, when analyzing the time distribution. This makes it for example possible to find unnecessary calls by checking the amount of function calls that are done during a specific action. This is even possible, when the execution of the action is done on multiple controllers, because the context of a call is still known after a change of the platform. The proposed solution requires no code modification that would need a rebuild and could change the system behavior and therefore affect the analyzed durations. The analysis is based on traces that are already part of the system. The trace file format is specified in a XML file, for example. The trace file data that are already inherent in the system are post-analyzed and it is not necessary to reproduce a certain scenario to be able to analyze the performance data. The specification of the keys and the entry and exit trace for each action is very flexible due to regular expression.

In this document a task represents one specific process executed on one specific controller and an action represents a function call on a controller including all nested cross process or cross controller function calls. So an action is performed by multiple tasks. A Trace file is a file, which contains several lines of text. Such a line is called trace line.

The above, as well as additional purposes, features, and advantages of the present invention will become apparent in the following detailed written description.

### BRIEF DESCRIPTION OF THE DRAWINGS

FIG. 1 is a schematic block diagram of a distributed computer system with apparatus for analyzing the distributed computer system, in accordance with an embodiment of the present invention.

FIG. 2 is a more detailed block diagram of the apparatus for analyzing the distributed computer system, in accordance with an embodiment of the present invention.

FIG. 3 is a schematic timing diagram showing different actions performed by components of the distributed computer system shown in FIG. 1.

FIG. 4 is a schematic flow chart of a method for analyzing a distributed computer system, in accordance with an embodiment of the present invention.

### DETAILED DESCRIPTION OF EXAMPLE EMBODIMENTS

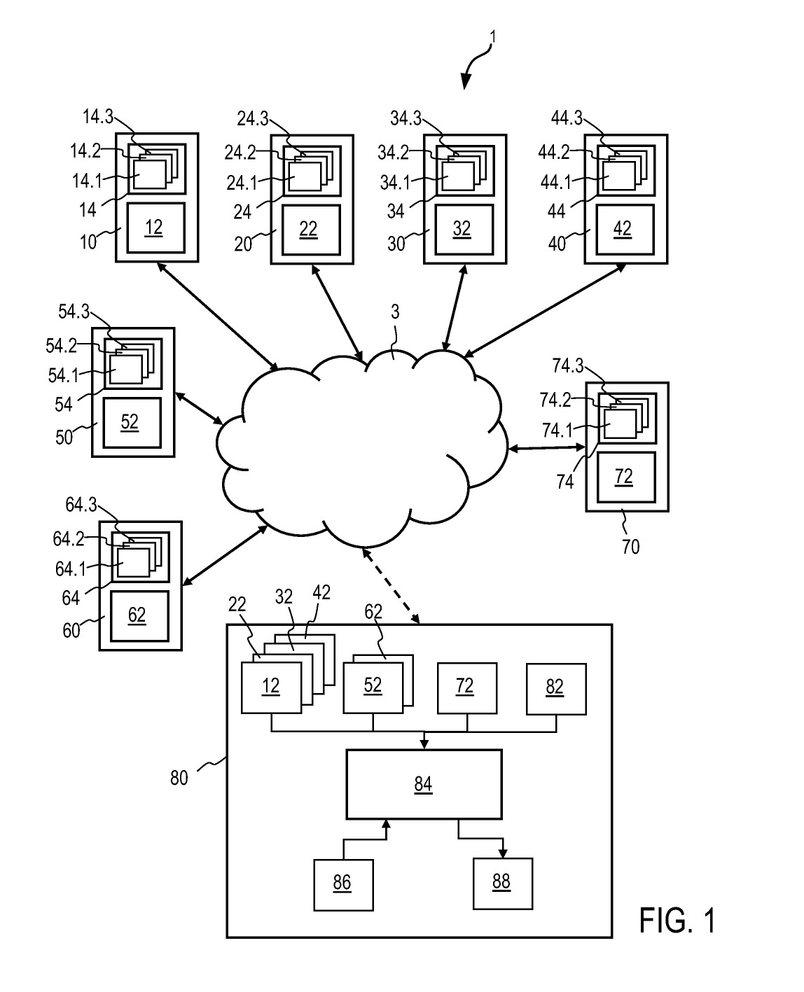

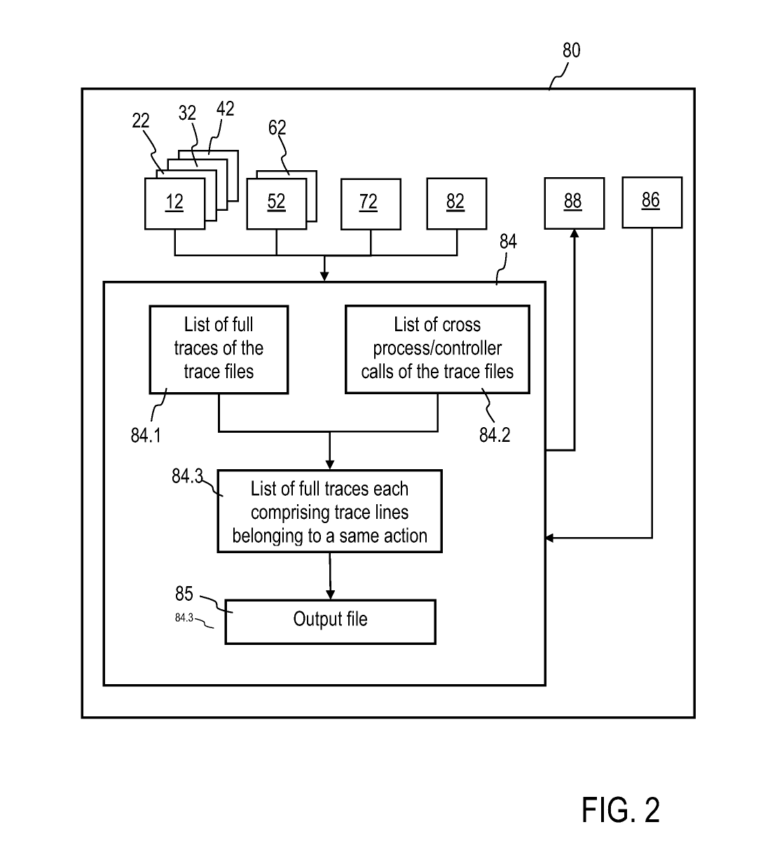

FIG. 1 shows a distributed computer system 1 with apparatus 80 for analyzing the distributed computer system 1, in accordance with an embodiment of the present invention and FIG. 2 shows is a more detailed block diagram of the apparatus 80 for analyzing the distributed computer system 1.

Referring to FIGS. 1 and 2, the shown embodiment of the distributed computer system 1 comprises four hardware units 10, 20, 30, 40 to process data, an interconnection network 3, two flexible support units 50, 60 and a support element 70 connected to the flexible support units 50, 60 to initialize the hardware units 10, 20, 30, 40 of the distributed computer system 1 by using the interconnection network 3. Each hardware unit 10, 20, 30, 40 comprises a processor 14, 24, 34, 44 executing different tasks 14.1, 14.2, 14.3, 24.1, 24.2, 24.3, 34.1, 34.2, 34.3, 44.1, 44.2, 44.3. During executing the different tasks 14.1, 14.2, 14.3, 24.1, 24.2, 24.3, 34.1, 34.2, 34.3, 44.1, 44.2, 44.3 are traced and written in related trace files 12, 22, 32, 42 each located in a corresponding hardware unit 10, 20, 30, 40. Each flexible support unit 50, 60 comprises an embedded controller with a support processor 54, 64 each executing different tasks 54.1, 54.2, 54.3, 64.1, 64.2, 64.3 and the support element 70 comprises a think pad with a processor 74 also executing different tasks 74.1, 74.2, 74.3. The executed tasks 54.1, 54.2, 54.3, 64.1, 64.2, 64.3, 74.1, 74.2, 74.3 are also traced and written in related trace files 52, 62, 72 each located in a corresponding flexible support unit 50, 60 or in the support element 70.

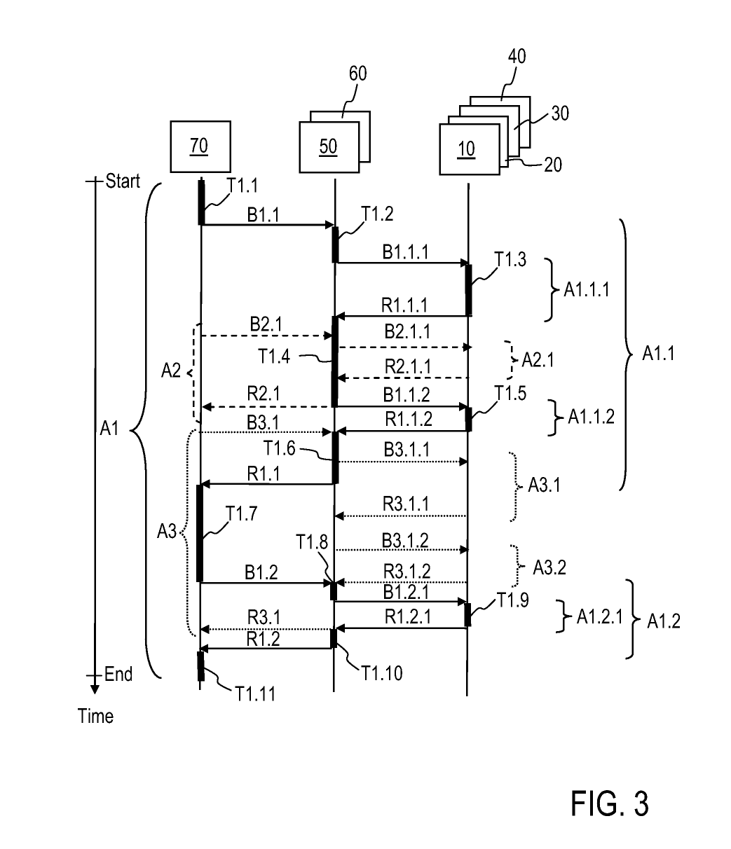

For analyzing the distributed computer system 1 the apparatus 80 is connected to the interconnection network 3 which connection is represented by a dashed double arrow. According to the invention a controller unit 84 of the apparatus 80 for analyzing the distributed computer system 1 is post-analyzing the different trace files 12, 22, 32, 42, 52, 62, 72 generated by the components 10, 20, 30, 40, 50, 60, 70 of the distributed computer system 1 and is identifying trace lines inside the different trace files 12, 22, 32, 42, 52, 62, 72 belonging to the same action A1, A1.1, A1.2, A1.1.1, A1.1.2, A1.2.1, A2, A2.1, A3, A3.1, A3.2 executed from at least one component 10, 20, 30, 40, 50, 60, 70 inside the distributed computer system 1 by using unique key expressions. Examples of the relationship of the actions A1, A1.1, A1.2, A1.1.1, A1.1.2, A1.2.1, A2, A2.1, A3, A3.1, A3.2 and the components 10, 20, 30, 40, 50, 60, 70 of the distributed computer system 1 are explained in accordance with FIG. 3. The controller unit 84 generates an output file 85 with context and/or time distribution information for related actions A1, A1.1, A1.2, A1.1.1, A1.1.2, A1.2.1, A2, A2.1, A3, A3.1, A3.2 by extracting trace lines representing cross process or cross controller calls and/or function calls for each related action A1, A1.1, A1.2, A1.1.1, A1.1.2, A1.2.1, A2, A2.1, A3, A3.1, A3.2 based on an input file 82. Further the apparatus 80 for analyzing the distributed computer system 1 comprises an input device 86 for inputting the input file 82 and an output device 88 for outputting the output file 85.

FIG. 3 is a schematic timing diagram showing different actions A1, A2, A3 performed by the components 10, 20, 30, 40, 50, 60, 70 of the distributed computer system 1 shown in FIG. 1. Referring to FIG. 3 in the shown example three different actions A1, A2, A3 are performed, wherein a first action A1 comprises two depending actions A1.1, A1.2. A first depending action A1.1 comprises another two depending actions A1.1.1 and A1.1.2 and a second depending action A1.2 comprises one depending action A1.2.1. A parallel performed second action A2 comprises one depending action A2.1. A parallel performed third action A3 comprises two depending actions A3.1, A3.2.

According to FIG. 3 the support element 70 performing the first action A1 executes a first task T1.1 after the start. At the end of the first task T1.1 the support element 70 performs a first call B1.1 to a first flexible support unit 50, which is performing a second task T1.2 after receiving the first call B1.1. At the end of the second task T1.2 the first flexible support unit 50 performs a first sub call B1.1.1 to a first hardware unit 10 of the distributed computer system 1. The first hardware unit 10 is performing a third task T1.3 after receiving the first sub call B1.1.1. At the end of the third task T1.3 the first hardware unit 10 performs a first sub return call R1.1.1 to the first flexible support unit 50, which is performing a fourth task T1.4 after receiving the first sub return call R1.1.1. At the end of the fourth task T1.4 the first flexible support unit 50 performs a second sub call B1.1.2 to a second hardware unit 20 of the distributed computer system 1. The second hardware unit 20 is performing a fifth task T1.5 after receiving the second sub call B1.1.2. At the end of the fifth task T1.5 the second hardware unit 20 performs a second sub return call R1.1.2 to the first flexible support unit 50, which is performing a sixth task T1.6 after receiving the second sub return call R1.1.2. At the end of the sixth task T1.6 the first flexible support unit 50 performs a first return call R1.1 to the support element 70, which is performing a seventh task T1.7 after receiving the first return call R1.1. At the end of the seventh task T1.7 the support element 70 performs a second call B1.2 to the first flexible support unit 50, which is performing an eighth task T1.8 after receiving the second call B1.2. At the end of the eighth task T1.8 the first flexible support unit 50 performs a first sub call B1.2.1 to a fourth hardware unit 40 of the distributed computer system 1. The fourth hardware unit 40 is performing a ninth task T1.9 after receiving the first sub call B1.2.1. At the end of the ninth task T1.9 the fourth hardware unit 40 performs a first sub return call R1.2.1 to the first flexible support unit 50, which is performing a tenth task T1.10 after receiving the first sub return call R1.2.1. At the end of the tenth task T1.10 the first flexible support unit 50 performs a second return call R1.2 to the support element 70, which is performing a eleventh task T1.11 after receiving the second return call R1.2 and ends the first action A1.

For the sake of clarity the tasks of the second and third parallel performed actions A2 and A3 between the calls and return calls are not shown in FIG. 3. During the first action A1 the support element 70 is performing the second action A2 during which the support element 70 is performing a first call B2.1 to a second flexible support unit 60, which is performing a task, not shown, after receiving the first call B2.1. At the end of the task the second flexible support unit 60 performs a first sub call B2.1.1 to a third hardware unit 30 of the distributed computer system 1. The third hardware unit 30 is performing a task, not shown, after receiving the first sub call B2.1.1. At the end of the task the third hardware unit 30 performs a first sub return call R2.1.1 to the second flexible support unit 60, which is performing a task, not shown, after receiving the first sub return call 82.1.1. At the end of the task the second flexible support unit 60 performs a first return call R2.1 to the support element 70, which ends the second action A2 after receiving the first return call R2.1.

During the first action A1 the support element 70 is also performing the third action A3 during which the support element 70 performs a first call B3.1 to the second flexible support unit 60, which is performing a task, not shown, after receiving the first call B3.1. At the end of the task the second flexible support unit 60 performs a first sub call B3.1.1 to a first hardware unit 10 of the distributed computer system 1. The first hardware unit 10 is performing a task, not shown, after receiving the first sub call B3.1.1. At the end of the task the first hardware unit 10 performs a first sub return call R3.1.1 to the second flexible support unit 60, which is performing a task, not shown, after receiving the first sub return call R3.1.1. At the end of the task the second flexible support unit 60 performs a second sub call B3.1.2 to the fourth hardware unit 40 of the distributed computer system 1. The fourth hardware unit 40 is performing a task, not shown after receiving the second sub call B3.1.2. At the end of the task the fourth hardware unit 40 performs a second sub return call R3.1.2 to the second flexible support unit 60, which is performing a task, not shown, after receiving the second sub return call R3.1.2. At the end of the task the second flexible support unit 60 performs a first return call R3.1 to the support element 70, which ends the third action after receiving the first return call R3.1.

Referring to FIGS. 1 to 3 the controller unit 84 creates a list 84.1 of full traces and a list 84.2 of calls by parsing each trace file 12, 22, 32, 42, 52, 62, 72 line by line, wherein each full trace and each call comprise trace lines belonging to the same action A1, A1.1, A1.2, A1.1.1, A1.1.2, A1.2.1 or A2, A2.1 or A3, A3.1, A3.2 in consecutive order. The controller unit 84 uses the list 84.1 of full traces and the list 84.2 of calls to create a list 84.3 comprising trace lines representing cross process or cross controller calls and/or function calls for each related action A1, A1.1, A1.2, A1.1.1, A1.1.2, A1.2.1 or A2, A2.1 or A3, A3.1, A3.2 based on the input file 82. The input file 82 describes format of the trace files 12, 22, 32, 42, 52, 62, 72 and specifies function calls and formats of cross process or cross controller calls to be analyzed. Additional each of the trace files 12, 22, 32, 42, 52, 62, 72 contains process identification information and timestamp information and unique key expressions. The trace files 12, 22, 32, 42, 52, 62, 72 and/or the input file 82 are specified as XML files, for example.

The controller unit 84 creates the list 84.3 of full traces each comprising trace lines belonging to the same action A1, A1.1, A1.2, A1.1.1, A1.1.2, A1.2.1 or A2, A2.1 or A3, A3.1, A3.2 executed from at least one component 10, 20, 30, 40, 50, 60, 70 inside the distributed computer system 1 by extracting cross process or cross controller calls and/or function calls based on an the input file 82 describing formats of the trace files 12, 22, 32, 42, 52, 62, 72 and specifying function calls and formats of cross process or cross controller calls to be analyzed.

The controller unit 84 analyzes each full trace of the list 84.3 of full traces to calculate duration of a function call specified by the input file 82 if a trace line representing said function call and a trace line representing a related function end is found inside the full trace.

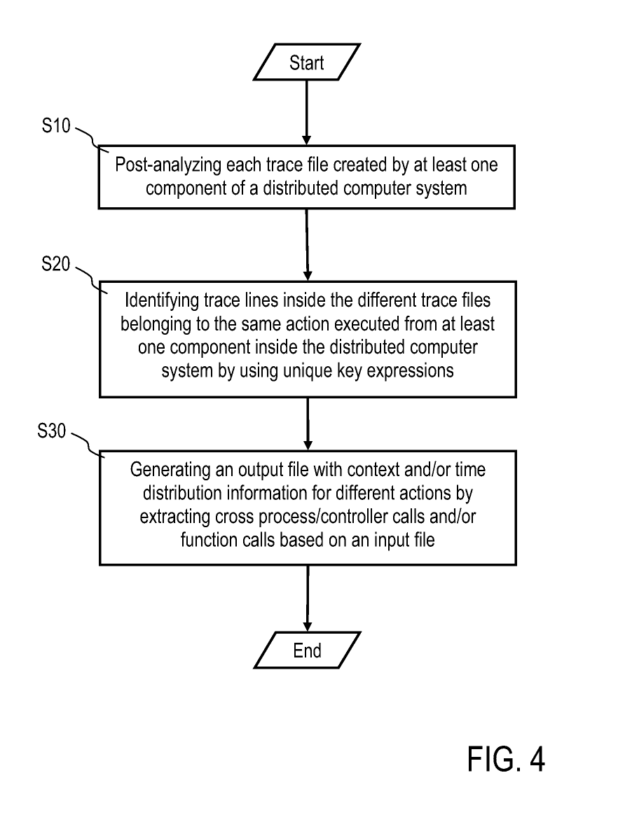

FIG. 4 is a schematic flow chart of a method for analyzing a distributed computer system, in accordance with an embodiment of the present invention.

Referring to FIG. 4 the flowchart depicts how the apparatus 80 for analyzing the distributed computer system 1 will be used. According to the embodiment of the inventive method for analyzing a distributed computer system different trace files 12, 22, 32, 42, 52, 62, 72 generated by components 10, 20, 30, 40, 50, 60, 70 of the distributed computer system 1 are post-analyzed during a step S10. During step S20 trace lines inside the different trace files 12, 22, 32, 42, 52, 62, 72 belonging to the same action A1, A1.1, A1.2, A1.1.1, A1.1.2, A1.2.1 or A2, A2.1 or A3, A3.1, A3.2 executed from at least one component 10, 20, 30, 40, 50, 60, 70 inside the distributed computer system 1 are identified by using unique key expressions.

As a result in the example of FIG. 3 the depending actions A1.1.1, A1.1.2 are identified as belonging to the depending action A1.1 and the depending action A1.2.1 is identified as belonging to the depending action A1.2, whereas the depending actions A1.1, A1.2 are identified as belonging to the action A1. The depending action A2.1 is identified as belonging to the action A2 and the depending actions A3.1, A3.2 are identified as belonging to the action A3. Further the begin of the first call B1.1 and the begin of the first sub call B1.1.1 and the first sub return call R1.1.1 and the begin of the second sub call B1.1.2 and the second sub return call R1.1.2 and the first return call R1.1 as part of the first call B1.1 are identified as belonging to the first action A1. Further the begin of the second call B1.2 and the begin of the first sub call B1.1.1 and the first sub return call R1.2.1 and the second return call R1.2 as part of the second call B1.2 are identified as belonging to the first action A1. Further the begin of the first call B2.1 and the begin of the first sub call B2.1.1 and the first sub return call R2.1.1 and the second return call R2.1 as part of the first call B2.1 are identified as belonging to the second action A2. Further the begin of the first call B3.1 and the begin of the first sub call B3.1.1 and the first sub return call R3.1.1 and the begin of the second sub call B3.1.2 and the second sub return call R3.1.2 and the first return call R3.1 as part of the first call B3.1 are identified as belonging to the third action A1.

During step S30 an output file 85 with context and/or time distribution information for different actions A1, A1.1, A1.2, A1.1.1, A1.1.2, A1.2.1, A2, A2.1, A3, A3.1, A3.2 is generated by extracting trace lines representing cross process or cross controller calls and/or function calls for each related action A1, A1.1, A1.2, A1.1.1, A1.1.2, A1.2.1, A2, A2.1, A3, A3.1, A3.2 based on the input file 82.

As a result in the example of FIG. 3 the trace lines representing the calls B1.1, B1.2, B2.1, B3.1, the return calls R1.1, R1.2, R2.1, R3.1, the sub calls B1.1.1, B1.1.2, B1.2.1, B2.1.1, B3.1.1, B3.1.2 and the sub return calls R1.1.1, R1.1.2, B1.2.1, B2.1.1, B3.1.1, B3.1.2 are extracted to generate the output file 85. The output file 85 is transformed in a format to be used in a SQL database or in a comma separated value list, for example. The different trace files 12, 22, 32, 42, 52, 62, 72 are analyzed, for example, to reduce a time duration of an initializing process of the distributed computer system 1.

In other words embodiments of the invention use several trace files 12, 22, 32, 42, 52, 62, 72 and an XML file as input put file 82. The XML file 82 describes the format of the trace files 12, 22, 32, 42, 52, 62, 72, which function calls should be analyzed and how cross process or cross controller calls look like in the different trace files 12, 22, 32, 42, 52, 62, 72. Embodiment of the invention extract cross process controller actions out of the different trace files 12, 22, 32, 42, 52, 62, 72 and search for the given function calls within the actions. To be analyzed each trace file must contain a process identification and a timestamp. Each trace file 12, 22, 32, 42, 52, 62, 72 has to be consecutive, that means that the trace lines are written in the order as they occur. Each trace file 12, 22, 32, 42, 52, 62, 72 has to contain a unique key for cross process or cross controller calls.

The format of a trace file is described with a tag “trace file format”. Regular expression define how the timestamp, the process identification and the trace line text itself can be extracted from a given trace file line. A “key” tag defines how a cross process or cross controller call can be identified in the trace files. Via regular expressions it defines how the unique key of such a call can be extracted from the trace line text. A “client” is the process which initiates a cross process call and a “server” is the process where that call is eventually executed. “Begin” is the start of the call and “return” is the end of the call where both of them are visible in the trace files of the client and the server. A “sub” tag defines the entry trace line and exit trace line of a function to be analyzed. Those tags can be nested to analyze nested function calls. So one trace line comprises time stamp, task identification, trace line text, which comprises optional a unique key in case of a call or return call. The task identification is a combination of process identification and trace file name. By this definition the task identification is a unique key to reference a process in one of the given trace files. The process identification alone need not be unique since the same process identification can exist on different controllers.

The list 84.1 of full traces of the trace files 12, 22, 32, 42, 52, 62, 72 is simply a list of trace lines, where the trace lines are in consecutive order that means that a trace line with a smallest timestamp is positioned first. The list 84.2 of cross process or cross controller calls of the trace files 12, 22, 32, 42, 52, 62, 72 contains the four entities which constitute a cross process or cross controller call. So embodiments of the invention try to find a trace line which matches a “Key” tag in the XML file 82 then add this item to the list 84.2 of cross process or cross controller calls of the trace files 12, 22, 32, 42, 52, 62, 72.

Embodiments of the invention can use different search function to identify items in the list 84.1 of full traces of the trace files 12, 22, 32, 42, 52, 62, 72 or in the list 84.2 of cross process or cross controller calls of the trace files 12, 22, 32, 42, 52, 62, 72. So a possible function may search forward in the list 84.1 of full traces of the trace files 12, 22, 32, 42, 52, 62, 72 or in the list 84.2 of cross process or cross controller calls of the trace files 12, 22, 32, 42, 52, 62, 72 and add identified items at the end of the list 83 of full traces each comprising trace lines belonging to a same action. An other possible function may search backward in the list 84.1 of full traces of the trace files 12, 22, 32, 42, 52, 62, 72 or in the list 84.2 of cross process or cross controller calls of the trace files 12, 22, 32, 42, 52, 62, 72 and add identified items at the begin of the list 83 of full traces each comprising trace lines belonging to a same action.

During step S30 the inventive method iterates through each line of the list 83 of full traces each comprising trace lines belonging to a same action and searches for function calls as specified by the user in the XML file 82. When an exit trace line is found duration of the function call is calculated. The data of the output file 85 can be transformed in various formats, e.g. into a SQL database or in a CSV (comma separated values) list which can be imported in a spreadsheet.

The inventive method for analyzing a distributed computer system can be implemented as an entirely software embodiment, or an embodiment containing both hardware and software elements. In an embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A method for analyzing a distributed computer system, the distributed computer system comprising at least one hardware unit to process data, an interconnection network and at least one processing unit to initialize said at least one hardware unit by using said interconnection network, the method comprising:
post-analyzing by a controller unit different trace files generated by components of said distributed computer system and
identifying by the controller unit, by using unique key expressions, trace lines inside said different trace files belonging to the same action executed from at least one component inside said distributed computer system, and
generating by the controller unit an output file with context or time distribution information for different actions by extracting trace lines representing cross process or cross controller calls or function calls for each related action based on an input file.

2. The method according to claim 1 further comprising creating by the controller unit a list of full traces and a list of calls by parsing each trace file line by line, wherein each full trace and each call comprises trace lines belonging to the same action in consecutive order.

3. The method according to claim 2, wherein said list of full traces and said list of calls are used to create a list comprising trace lines representing cross process or cross controller calls or function calls for each related action based on said input file.

4. The method according to claim 1 wherein said input file describes format of said trace files and specifies function calls and formats of cross process or cross controller calls to be analyzed.

5. The method according to claim 1 wherein each of said trace files contains process identification information and timestamp information and unique key expressions.

6. The method according to claim 1 wherein said trace files and said input file are specified as XML files.

7. The method according to claim 1 wherein said different trace files are analyzed to reduce time duration of an initializing process of said distributed computer system.

8. The method according to claim 1 wherein said output file is transformed in a format to be used in a Structured Query Language (SQL) database or in a comma separated value list.

9. Apparatus for analyzing a distributed computer system, the apparatus comprising:
the distributed computer system, including at least one hardware unit to process data, an interconnection network and at least one processing unit to initialize said at least one hardware unit by using said interconnection network, and
a controller unit, the controller unit post-analyzing different trace files generated by components of said distributed computer system and identifying trace lines inside said different trace files belonging to the same action executed from at least one component inside the distributed computer system by using unique key expressions,
wherein said controller unit generates an output file with context or time distribution information for related actions by extracting trace lines representing cross process or cross controller calls or function calls for each related action based on an input file.

10. The apparatus according to claim 9 wherein said controller unit creates a list of full traces each comprising trace lines belonging to the same action executed from at least one component inside the distributed computer system by extracting cross process or cross controller calls or function calls based on an said input file describing formats of said trace files and specifying function calls and formats of cross process or cross controller calls to be analyzed.

11. The apparatus according to claim 10 wherein said controller unit analyzes each full trace of said list of full traces to calculate duration of a function call specified by said input file if a trace line representing said function call and a trace line representing a related function end is found inside said full trace.

12. The apparatus according to one of the preceding claim 9, wherein said at least one processing unit comprises at least one flexible support unit and at least one support element connected to said at least one flexible support unit.

13. The apparatus according to claim 12 wherein said at least one flexible support unit comprises an embedded controller with a support processor executing different tasks, wherein said at least one support element comprises a think pad with a processor executing different tasks.

14. A computer program product stored on a computer-readable, recordable storage medium, the computer program product comprising computer program instructions configured for installation upon and operation of a distributed computer system comprising at least one hardware unit to process data, an interconnection network and at least one processing unit to initialize said at least one hardware unit by using said interconnection network, the computer program instructions when executed causing the distributed computer system to function by:
post-analyzing by a controller unit different trace files generated by components of said distributed computer system and
identifying by the controller unit, by using unique key expressions, trace lines inside said different trace files belonging to the same action executed from at least one component inside said distributed computer system, and
generating by the controller unit an output file with context or time distribution information for different actions by extracting trace lines representing cross process or cross controller calls or function calls for each related action based on an input file.

15. The computer program product according to claim 14 wherein the computer program instructions are further configured to cause the distributed computer system to function by creating by the controller unit a list of full traces and a list of calls by parsing each trace file line by line, wherein each full trace and each call comprises trace lines belonging to the same action in consecutive order.

16. The computer program product according to claim 15, wherein said list of full traces and said list of calls are used to create a list comprising trace lines representing cross process or cross controller calls or function calls for each related action based on said input file.

17. The computer program product according to claim 14 wherein said input file describes format of said trace files and specifies function calls and formats of cross process or cross controller calls to be analyzed.

18. The computer program product according to claim 14 wherein each of said trace files contains process identification information and timestamp information and unique key expressions.

19. The computer program product according to claim 14 wherein said different trace files are analyzed to reduce time duration of an initializing process of said distributed computer system.

20. The computer program product according to claim 14 wherein said output file is transformed in a format to be used in a Structured Query Language (SQL) database or in a comma separated value list.
